(19) United States
(12) Patent Application Publication
(10) Pub. No.: US 2005/0287258 A1
(43) Pub. Date: Dec. 29, 2005

(54) Product dip conveyor system

(76) Inventor: Thomas Edward Kilburn, Pennsburg, PA (US)

Correspondence Address: Joshua L. Cohen, BOC, Inc., Legal Services-IP Dept., 575 Mountain Ave., Murray Hill, NJ, 07974, US

(21) Appl. No.: 10/873,707

(22) Filed: Jun. 23, 2004

(51) Int. Cl. A23L 1/27

(52) U.S. Cl. 426/310

(57) ABSTRACT

A system for treating food product includes a tank filled with a treatment solution such as a disinfecting solution; a conveyor system including a conveyor belt disposed and moving through the tank with trays spaced along the conveyor belt which are adapted to receive the food product; and a perforated retainer member to maintain the food product in the solution between adjacent trays for exposure to the solution and to prevent the food product from floating away from the proximity of the conveyor system.

### TECHNICAL FIELD

The present invention relates to a system used to disinfect food products including, but not limited to, hot dogs, sausage, and bratwurst. More specifically, the invention relates to a system used to disinfect food products with a disinfecting or anti-microbial solution.

### BACKGROUND

In the field of food processing, it has been difficult to thoroughly clean or disinfect batches of food products quickly, continuously and sufficiently. Previously, food products such as hot dogs, sausage, and bratwurst have been loaded into large vats filled with a treatment solution. However, because the food products are individually loaded into the vat, the food products would be exposed to the solution for different time periods if the food products were thereafter removed in batches. To provide uniform time periods of exposure, another procedure was to load a batch of food products into the solution. However, since various food products are unevenly distributed in the vat, it has been difficult to insure that the batch of food products is completely bathed in the solution for the necessary amount of time.

Known immersion systems include large horizontally oriented vats to process the food products, and such vats have a large footprint which consumes valuable surface area on the processing or factory floor.

Therefore, there is a need for a system to be able to completely and continously expose batches of food products for select uniform periods of time to disinfecting solutions for the food products, the system requiring both reduced floor space and user intervention.

### SUMMARY OF THE INVENTION

There is accordingly provided in the present invention a system for contacting product with a solution comprising a container for the solution and in which the product is exposed to the solution, a conveyor for conveying the product through the solution in the container, and retaining means disposed at the container for retaining the product in the treatment solution proximate the conveyor, the retaining means comprising a passageway through which the conveyor travels for providing fluid communication of the solution with the product.

An apparatus is provided for bathing food product in a treatment solution comprising a tank, a treatment solution in the tank, a conveyor disposed for movement through the tank to convey the food product through the treatment solution, a guide assembly coacting with the conveyor to guide movement of said conveyor through said tank, and a retaining member at said tank for providing a passage through said tank for said conveyor, said retaining member retaining said food product in the passage proximate to said conveyor for exposure to the treatment solution.

A process for treating a food product with a solution is provided comprising providing the food product to be exposed to a solution, conveying the food product on a conveyor to the solution, guiding the food product with the conveyor through the solution, retaining the food product being guided through the solution from being floatably displaced away from proximity to the conveyor during transport through the solution, and removing the food product from the solution with the conveyor.

A process for treating food product with a solution is provided comprising providing a passage in the solution, moving the food product through the passage, buoyantly displacing the food product in the passage for exposure to the solution, and removing the food product from the solution.

### BRIEF DESCRIPTION OF THE DRAWINGS

For a more complete understanding of the invention, reference may be had to the drawing Figures included, of which:

FIG. 1 is a cross-sectional view of the product dip conveyor system; and

FIG. 2 is a perspective view of a feature of the system shown in FIG. 1.

### DETAILED DESCRIPTION

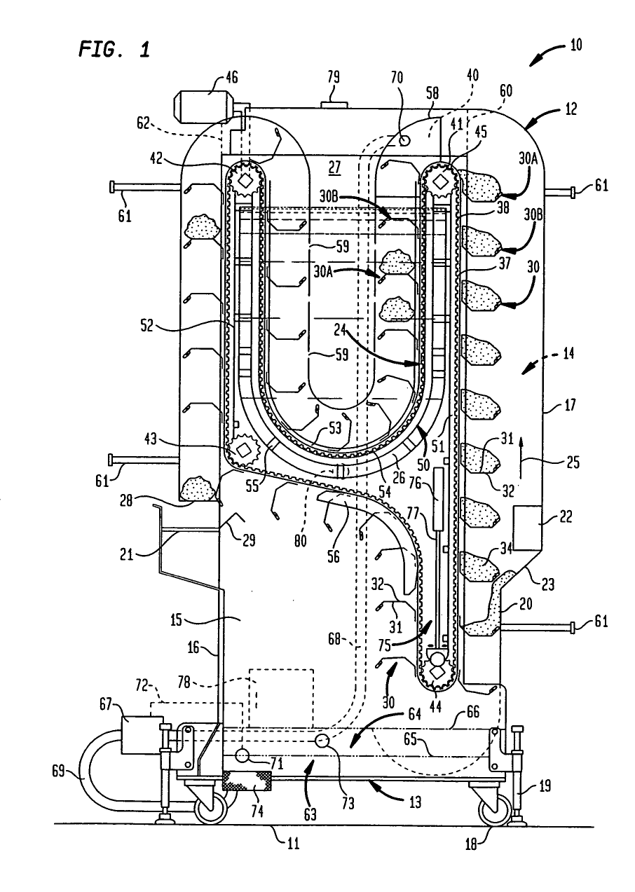

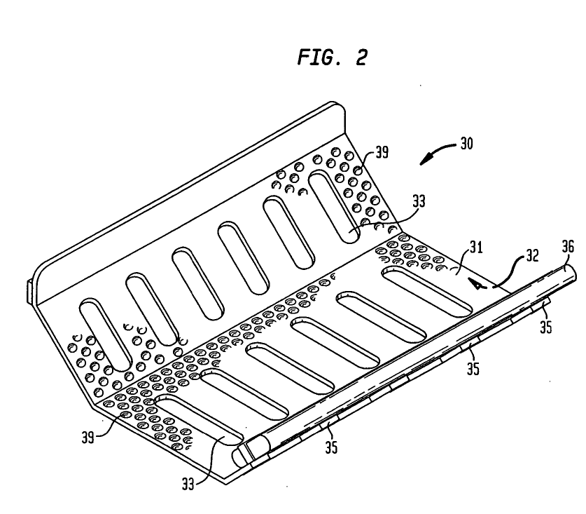

Referring to FIGS. 1 and 2, the product dip conveyor system, hereinafter referred to as the “system”, is indicated generally at 10. The system 10 includes a housing 12 having a bottom 13 and a plurality of side walls, i.e. a front side wall 14, a rear side wall 15, a first side wall 16 and second side wall 17 (“sidewalls 14-17”). To insure mobility and stability with respect to an underlying surface 11, such as for example at a factory floor, casters 18 and stabilizers 19 are mounted to the bottom 13. Once the system 10 is positioned for its intended use, the casters 18 are locked and the stabilizers 19 extended to stabilize the housing 12 at a select location upon the underlying surface 11.

A product feed mechanism (not shown) or an “upstream” piece of processing equipment such as a peeler device (not shown) disposed at an exterior of the housing 12 delivers food product 20 (e.g., hot dogs, sausage, bratwurst, etc.) to the system 10 by, for example, a conveyor (not shown) constructed and arranged to transport the food product 20 to the system 10. The food product 20 may consist instead of the unfinished composition to manufacture the hot dogs, etc.

The feed mechanism delivers the food product 20 to the housing 12 through a product infeed opening 22 of the sidewall 17, which is configured to allow the food product 20 to enter the housing 12 without obstruction. An infeed ramp 23 is used to transfer the food product 20 to a conveyor assembly generally indicated at 24 and disposed in the housing 12.

The conveyor assembly 24 transports the food product 20 through the system 10 in the direction of arrow 25 by delivering the food product 20 from the infeed ramp 23 to an immersion tank 26, and thereafter to an outfeed opening 28. An outfeed ramp 29 is provided adjacent the outfeed opening 28 to direct the food product 20 from the conveyor assembly 24 to a removal mechanism, such as a outfeed conveyor belt 21. The removal mechanism is configured to remove the food product 20 from the system to a remote location for further processing if necessary.

During operation of the system 10, the conveyor assembly 24 transports the food product 20 to be exposed, such as bathed, in a disinfecting or anti-microbial solution (hereinafter “solution”) 27 provided in the immersion tank 26. The solution 27 disinfects the food product 20 before further processing thereof, and is preferably an anti-microbial liquid. To enhance efficiency, the system 10 can be operated in a continous process. Moreover, operation of the system 10 insures that each batch of the food product 20 is in contact with the solution for a predetermined period of time.

Referring to FIG. 2, to facilitate batch processing of the food product 20, the conveyor assembly 24 includes a plurality of buckets or trays, also referred to as flights 30, each of which is formed with at least one and preferably a plurality of slotted apertures 33 therethrough for a purpose describe below. The trays 30 each include a first side 31 and a second side 32 opposite to the first side 31, and are adapted to carry a batch 34 of the food product 20 as shown in FIG. 1. Each tray 30 includes preferably a plurality of fingers 35 which extend from the tray 30. The fingers 35 support a lip 36 of preferably a polymer material, such as for example ultra high molecular weight (UHMW) polyethylene. The arrangement of the lip 36 with respect to the corresponding tray 30 is to retain food product on the trays 30 prior to, and during the immersion process. The lip 36 can alternatively be mounted directly to the tray without use of the fingers 35. Each tray 30 is provided with a myriad of dimples or depressions along the surface at sides 31, 32 to reduce adhesion of the food product to the sides 31, 32 and facilitate food product removal from the trays 30.

The trays 30 may each be removably mounted to a conveyor belt 37 for maintenance, cleaning and repair. The conveyor belt 37 is arranged as a continues loop at the interior of the housing 12, and consists of a multiplicity of hingedly connected modules. Each tray 30 is releasably attached to a corresponding one of the modules. The modules each include teeth 38 adapted for co-action as discussed below.

As shown in FIG. 1, the conveyor belt 37 is guided and driven by a plurality of sprockets which include: a first upper sprocket 41, a second upper sprocket 42, an intermediate sprocket 43 and a lower sprocket 44 (“sprockets 41-44”). Each of the sprockets 41-44 include teeth 45 adapted to coact with the teeth 38 of the modules. As such, at least one of the sprockets 41-44 drive the conveyor belt 37 within the housing 12. By way of example, the second upper sprocket 42 is connected to an AC drive gear motor 46 for driving the sprocket 42 and hence, the conveyor belt 37.

A guide assembly shown generally at 50 is provided to further direct the movement of the conveyor belt 37. The guide assembly 50 consists of components disposed for coaction with the immersion tank 26. The guide assembly 50 consists of a first guide member 51 preferably oriented vertically, a second guide member 52 preferably oriented vertically, and a pair of arcuate-shaped guide members 53, 54. The guide members 53, 54 are disposed within the immersion tank 26. The arcuate shaped guide member 54 is supported by struts 55 at an interior of the immersion tank 26. All the guide members 51-54 are preferably formed of a polymer or material similar to that which is used to manufacture the conveyor belt 27.

The first guide member 51 is preferably orientated vertically with respect to the housing 12 to thereby guide the conveyor belt 37 vertically toward the first upper sprocket 41. The first guide member is disposed external to the immersion tank 26. The arcuate guide members 53, 54 are arranged in the immersion tank 26 at opposed sides of the conveyor belt 37 and are constructed and arranged with sufficient rigidity to direct the conveyor belt 37 in a U-shaped direction within the immersion tank 26. The conveyor belt 27 moves between the arcuate guide members 53, 54 which are disposed at opposed sides of the conveyor belt 27.

The arcuate guide members 53, 54 preferably do not span the entire width of the conveyor belt 27 so as not to impede movement of the belt with the trays 30 being transported therewith.

In construction, each of the arcuate guide members 53, 54 can be arranged as strips in registration with edge portions of the conveyor belt 27 to direct the conveyor belt 27 in the U-shaped path within the immersion tank 26. The struts 55 support the arcuate guide member 54 above the inner surface of the immersion tank 26 so that the solution 27 can completely fill the immersion tank 26. The second guide member 52 is arranged external to the immersion tank 26 to direct the conveyor belt 37 exiting the immersion tank 26 in a downward vertical direction to the outfeed opening 28.

The material used to construct the conveyor belt 27 and the guide members 51-54 is preferably of similar or complimentary materials so that the sliding engagement of the conveyor belt 37 with respect to the guide members 51-54 will facilitate a smooth, uninterrupted, uniform flow of the conveyor belt 27 throughout the immersion process and the housing 12.

The guide assembly 50 also includes a perforated guide 58 which extends into the immersion tank 26 and over the path of the conveyor belt 37 in the tank 26. The perforated guide 58 functions as a duct with a passageway 40 through which the conveyor belt 37 and trays 30 effectively transport the food product 20 through the immersion tank 26, as will be further discussed below. The guide 58 is formed with a plurality of apertures 59 therethrough. The apertures 59 permit the solution 27 in the tank 26 to communicate freely to contact the food product 20 deposited on the trays 30; yet each aperture 59 is smaller than the individual food product 20 to prevent same from escaping through the apertures 59 to the central area of the tank 26.

The housing 12 is constructed with portions that are dispaceable at the infeed 22 and at the outfeed 28 provide access to the conveyor belt 37 and an interior of the housing 12. An infeed module 60 of the housing 12 is releasably engagable to the remainder of the housing 12 such that the module 60 can be displaced from the housing to move along the support rods 61 away from the housing 12. The outfeed module 62 is similarly releasably engagable to the remaining portion of the housing 12 and can be displaced from same to move along the support rods 61 away from housing 12 for access to the conveyor belt 37 at the outfeed opening 28 of the housing 12. The outfeed conveyor belt 21 and the outfeed opening 28 are disposed at a select position at the outfeed module 62.

The operation of the product dip conveyor system 10 will hereinafter be described by way of example referring to certain of the trays 30, indicated as tray 30A and tray 30B, as shown in FIG. 1. The system 10 and related process provides for accurate uniform residency time of the food product exposed to the solution 27.

In operation, the food product 20 enters the housing 12 through the infeed opening 22. The trays 30 are moved upwardly with the conveyor belt 37 relative to the infeed opening 22 through operation of the motor 46 driving the belt 37. As the trays 30A and 30B pass the infeed opening 22, they are loaded with food product 20 entering the housing 12. For example, food product 20 introduced into the housing 12 through the opening 22 slides down the infeed ramp 23 to be loaded onto the trays 30A and 30B.

Because the conveyor belt 37 is maintained, for example, at a constant speed of approximately ten feet per second (10 ft./sec), and the amount of food product 20 entering the housing 12 is maintained at a constant feed rate by the feed mechanism, the amount of food product 20 loaded onto the trays 30A and 30B can be uniform and accurately controlled. However, by varying the speed of the conveyor belt 37, or by varying the amount of food product 20 entering the housing via the feed mechanism, the amount of food product 20 carried by the trays 30A and 30B can be selectively adjusted.

After a batch 34 of food product 20 is loaded onto the first side 31 of each of the trays 30A and 30B, each batch 34 is initially moved in an upward direction by the conveyor belt 37. The conveyor belt 37 and trays 30A and 30B are initially directed along the first guide member 51.

Upon reaching the first upper sprocket 41, the trays 30A, 30B enter the perforated guide 58, and the conveyor belt 37 is redirected substantially one-hundred-eighty degrees (180°) downwardly into the immersion tank 26 due to the arrangement of the arcuate guide members 53, 54. The perforated guide 58 extends over the guide members 53, 54; the apertures 59 of the guide 58 providing fluid communication for the solution 27 in the immersion tank 26 to contact the trays and the batch 34.

During the transition of the conveyor belt 37 and trays 30A, 30B over the first upper sprocket 41, the batch 34 of food product 20 loaded onto the first side 31 of tray 30B falls under the effect of gravity onto the second side 32 of preceding tray 30A, for immersion into the solution 27 in the immersion tank 26. The sides 31, 32 of each tray 30 are sized and shaped to catch and support the batch 34 dropped from the next successive or following tray 30.

The buoyancy of the food product 20 may cause the batch 34 to rise off the second surface 32 of tray 30A and float toward the surface of the solution 27. Although the movement of the trays 30A and 30B through the solution 27 would normally cause oscillations of the solution 27, thereby causing the batch 34 to drift away from the belt 37 and into the center of the immersion tank 26, the perforated guide 58 maintains the batch 34 in proximity to the belt 37 and between trays 30A and 30B. As such, as tray 30B is moving downwardly along the U-shaped guide, the first side 31 of tray 30B captures the batch 34 of food product 20, which had floated off the preceding tray that it had landed on, and carries that batch 34 until the tray 30B reaches the lower region of the tank 26.

The lip 36 contacts or is in close proximity to the perforated guide 58 to prevent batch 34 from escaping its position between adjacent trays 30, such as trays 30A, 30B.

At the lower region of the immersion tank 26 the conveyor belt 37 and trays 30A and 30B transition again substantially one-hundred-eighty degrees (180°) from downward movement to upward movement to exit the tank 26. After the transition of trays 30A and 30B upwardly along the arcuate guide member 53, the batch 34 of food product 20, due to its buoyancy, may float in the solution 27. As the batch 34 is trapped between trays 30A and 30B, the batch 34 remains submerged in the solution 27 at a position adjacent to the second side 32 of the preceding tray 30A. The perforated guide 58 continues to retain the batch 34 in proximity to the conveyor belt 37.

After reaching the surface of the solution 27 in the immersion tank 26, the batch 34 that was submerged adjacent the second surface 32 of tray 30A floats until being captured by the first side 31 of tray 30B as tray 30B emerges from the solution 27.

As a result of the movement of trays 30A and 30B through the immersion tank 26, the batch 34 trapped therebetween has been forcibly submerged. Furthermore, because the batch 34 is buoyant during its movement in the submersion tank 26, the batch 34 is completely immersed and bathed in the solution 26.

After exiting the solution 27, the conveyor belt 37 and trays 30A and 30B move over the second upper sprocket 42 and are transitioned substantially one-hundred-eighty degrees (180°) downwardly along the second guide member 52. The batch 34 is contained between the trays 30A and 30B in the solution 27 by the perforated guide 58 until the trays 30A and 30B reach the second upper sprocket 42. Consequently, the batch 34 previously carried by the first side 31 of tray 30B falls onto the second side 32 of tray 30A.

The apertures 33 of the trays 30 permit same to drain more rapidly and such construction reduces the resistance of the tray during movement through the solution, thereby facilitating movement of the trays 30 through the solution 27. Movement of the trays 30 through the solution 27 forces the solution through the tray apertures 33 to displace the food product 34 which has fallen off the first side 31 of the following tray (30B) to rest on second side 32 of the proceeding tray (30A).

After reaching the intermediate sprocket 43, the conveyor belt 37 is redirected or transitioned by the convex-shaped guide member 56 toward the lower sprocket 44 for subsequent loading of the food product 20 at the infeed ramp 23. The guide member 56 is preferably constructed of a material similar to that which was used to construct the guide members 51-54. Due to the transition of the conveyor belt 37 by the convex-shaped guide member 56, the batch 34 from the second side 32 of tray 30A is dropped onto the outfeed conveyor belt 21 for discharge and removal. The dimples 39 at the sides 31, 32, of the trays 30 substantially reduce if not eliminate adhesion of the food product 20 to the sides 31, 32, so as to facilitate removal of the batch 34 from the trays 30. The outfeed ramp 29 is provided adjacent the outfeed opening 28 to insure that the batch 34 exits the housing 12 through the outfeed opening 28 to the outfeed belt 21.

A circulation system shown generally at 63 is provided to replenish and maintain the solution 27 in the immersion tank 26, as the solution 27 may be displaced or depleted by operation of the conveyor assembly 24. That is, the trays 30 and the food product 20 loaded thereon displace solution 27 when being forcibly submerged in the tank 26 and the circulation system 64 is open sided facing the tank 26, and is may be provided to effectively maintain the level of the solution 27 in the immersion tank 26 despite such activity. Solution 27 is lost from the tank 26 through the adhesion of the solution 27 to the conveyor belt 37, trays 30 and food product 20 exiting the tank 26. Evaporation of the solution 27 may also necessitate replenishment of same.

As part of the circulation system 63, the bottom 13 of the housing 12 is sealed to provide a reservoir 64. The reservoir 64 is open-sided facing the tank 26, and is configured to hold solution used to replenish the solution 27 in the immersion tank 26 to a select level. The reservoir 64 holds solution which is initially for the system 10, solution which is supplied from a source (not shown) external to system 10, and solution which overflows the immersion tank 26 due to displacement therefrom.

Upon operation of the system 10, the solution in the reservoir 64 may be at a level indicated generally at 65 (in one embodiment, approximately 9 gallons). However, as the system 10 is operating, the solution is pumped from the reservoir 64 to the immersion tank 26. As such, any solution 27 displaced by the food product 20 overflows the submersion tank 26, and is captured in the reservoir 64. During operation of the system 10, the solution is at a level 65 in the reservoir 64 and can increase to a level 66 representing for example 9 gallons and 20 gallons, respectively.

The circulation system 63 includes a circulation pump 67 to supply solution to the immersion tank 26 through circulation line 68. The circulation line 68 extends from the circulation pump 67 to discharge at a discharge port 70 above the immersion tank 26. The circulation pump 67 is positioned adjacent the lower proximity of the housing 12, and fluidly communicates with reservoir 64 through pump line 69. The circulation pump 67 draws solution from the reservoir 64 through the pump line 69 and moves the solution through the circulation line 68 to replenish the immersion tank 26 with solution 27.

The circulation system 63 also includes a level switch 71 for sensing the level of solution 27 in the reservoir 64. The switch 71 is connected by a signal line 72 to the circulation pump 67 and generates a signal to activate the pump 67 if the level of solution 27 in the reservoir 64 is not sufficient for operation. Thereafter, a supply of solution may be provided via solution input port 73 to the reservoir 64 until the solution reaches level 66 or other desired level.

A reservoir sump screen or filter 74 is disposed in the pumpline 69 where the line 69 is in fluid communication with the reservoir 64. The filter 74 screens any unwanted particulate matter from returning to the pump 67 and the immersion tank 26. Other filter elements may be used at the reservoir 64 to remove fats, oils, greases and other undesirable compositions.

During operation of system 10, tension in the conveyor belt 37 is maintained by a belt tensioner generally indicated at 75. The belt tensioner 75 includes a pneumatic cylinder 76 having a piston or reciprocating arm 77 extending therefrom. A distal end of the piston 77 is connected to the lower sprocket 44. The piston 77 is activated by the pneumatic cylinder 76 for the piston 77 to move the lower sprocket 44 to correctly tension the conveyor belt 37.

A door 78 of the housing 12 provides access to an interior of the housing. One of the sidewalls 14-17 may also be constructed with a removable panel (not shown) to provide more direct access to the immersion tank 26, perforated guide 58 and conveyor belt 37. A top access port 79 provides access to an interior of the housing 12 above the immersion tank 26. A drain port 80 is provided in a sidewall of the housing 12, such as the front sidewall 14. The drain port 80 is in fluid communication with the immersion tank 26 to drain solution 27 therefrom, or to sample existing solution in the tank 26 to determine efficacy of the solution 27.

The features of the system 10 enable the user to strictly control the residence time of the product exposure to the solution 27. The arrangement of the continuous conveyor belt 37 of the system 10 provides for the housing 12 of the system 10 to occupy a smaller area of the underlying surface 11 of a factory floor.

It will be understood that the embodiments described herein are merely exemplary, and that a person skilled in the art may make many variations and modifications without departing from the spirit and scope of the invention. All such variations and modifications are intended to be included within the scope of the invention as described hereinabove and claimed. It should be understood that any embodiments described hereinabove are not only in the alternative, but can also be combined.

1. A system for contacting product with a solution, comprising:
a container for the solution and in which the product is exposed to the solution;
a conveyor for conveying the product through the solution in the container; and
retaining means disposed at the container for retaining the product in the treatment solution proximate the conveyor, the retaining means comprising a passageway through which the conveyor travels for providing fluid communication of the solution with the product.

2. The system according to claim 1, wherein the retaining means further comprises a shield constructed and arranged to provide the passageway, and at least one aperture disposed in the shield for the solution to communicate with the passageway.

3. The system according to claim 1, further comprising a reservoir for the solution, the reservoir in fluid communication with the container.

4. The system according to claim 3, further comprising solution control means interconnecting the container and the reservoir for controlling an amount of solution for the container.

5. The system according to claim 4, wherein the solution control means comprises a conduit fluidly connecting the reservoir with the container, and a pump for moving solution through the conduit between the reservoir and the container.

6. The system according to claim 1, further comprising tensioning means coacting with the conveyor for providing a select amount of tension to the conveyor.

7. The system according to claim 1, wherein the container comprises a tank having an inlet and an outlet for the conveyor.

8. The system according to claim 1, wherein the conveyor comprises a belt and at least one tray mounted to the belt for conveying the product.

9. The system according to claim 8, wherein the at least one tray comprises at least one aperture therethrough.

10. The system according to claim 8, wherein the at least one tray comprises and an elongated edge for coaction with the retaining means to retain the product proximate the conveyor.

11. The system according to claim 8, wherein the belt forms a continuos loop for conveying the product.

12. The system according to claim 1, wherein the conveyor comprises a belt having a plurality of trays attached thereto, each one of said trays having a first side and a second side opposed to said first side, said retaining means retaining said product in said solution between the first side of said one of said trays and the second side of an adjacent one of said trays.

13. The system according to claim 8, where said at least one tray comprises a longitudinal member extending from said tray and being in close proximity to said retaining means when said conveyor is in said container.

14. The system according to claim 1, wherein said container comprises an infeed opening at one side of the container and an outfeed opening at another side of the container, said product conveyed by said conveyor from said infeed opening into the container and solution to the outfeed opening.

15. The system according to claim 1, further comprising guide means disposed at the container for guiding the conveyor in the system.

16. The system according to claim 15, wherein said guide means comprises a substantially U-shaped portion disposed at said container for guiding said conveyor along a substantially U-shaped path in said container.

17. The system according to claim 15, wherein said guide means comprises a pair of U-shaped members constructed and arranged to contact the conveyor to conform to said U-shaped members during movement in said container.

18. The system according to claim 6, wherein said tensioning means comprises a pneumatic cylinder and a reciprocating piston actuated by said cylinder, said piston having a distal end disposed for coaction with the conveyor for tensioning said conveyor.

19. The system according to claim 1, wherein the solution is selected from the group consisting of a disinfecting solution, an antimicrobial solution, a pathogen intervention solution, and any combination thereof.

20. An apparatus for bathing food product in a treatment solution, comprising: p1 a tank;
a treatment solution in the tank;
a conveyor disposed for movement through the tank to convey the food product through the treatment solution;
a guide assembly coacting with the conveyor to guide movement of said conveyor through said tank; and
a retaining member at said tank for providing a passage through said tank for said conveyor, said retaining member retaining said food product in the passage proximate to said conveyor for exposure to the treatment solution.

21. A process for treating a food product with a solution, comprising:
providing the food product to be exposed to a solution;
conveying the food product on a conveyor to the solution;
guiding the food product with the conveyor through the solution;
retaining the food product being guided through the solution from being floatably displaced away from proximity to the conveyor during transport through the solution; and
removing the food product from the solution with the conveyor.

22. The process according to claim 21, wherein retaining the food product further comprises:
allowing said food product to be floatably displaced from a portion of said conveyor upon entering said treatment solution; and
capturing said food product with another portion of said conveyor to prevent said food product from floating away from a proximity of said conveyor.

23. A process for treating food product with a solution, comprising providing a passage in the solution, moving the food product through the passage, buoyantly displacing the food product in the passage for exposure to the solution, and removing the food product from the solution.

24. The process according to claim 23, wherein said treating occurs continuously.

25. The process according to claim 23, wherein moving the food product further comprises transitioning the food product from movement in a first direction in the passage to movement in a second direction in the passage different from the first direction.
